(19) United States
(12) Patent Application Publication
(10) Pub. No.: US 2007/0284975 A1
(43) Pub. Date: Dec. 13, 2007

(54) Hanging file folder retainer

(75) Inventor: Donald B. Meltzer, Aurora, CO (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: American Pad & Paper LLC

(21) Appl. No.: 11/453,171

(22) Filed: Jun. 13, 2006

(51) Int. Cl. B42F 15/00

(52) U.S. Cl. 312/184

(57) ABSTRACT

An exemplary hanging file folder retainer is provided that, in one embodiment, includes a first attaching member, a second attaching member, and a retaining member. The first and second attaching members couple to a hanging file drawer rail in order to secure the hanging file folder retainer to the hanging file drawer rail. The second attaching member is linearly disposed from the first attaching member such that the hanging file folder retainer is secured to the hanging file drawer rail in at least two locations. The retaining member has a length sufficient to at least span the distance between said first and second attaching members and is functionally coupled to the first and second attaching member such that, in at least one functional position, the retaining member inhibits hanging file tabs from disengaging from the hanging file drawer rail.

### TECHNICAL FIELD OF THE INVENTION

This invention relates in general to the field of office equipment and, more particularly to hanging file folder cabinets, and even more particularly to hanging file folder rails.

### BACKGROUND OF THE INVENTION

Even in the so called paperless world ushered in by the computer age, businesses continue to obtain and produce enormous quantities of paper documents that must be retained and stored. One method of organizing and storing these documents, as well as other items, is through the use of file folders for organizing and arranging documents relating to the same or similar matter together in the same place. These file folders are then routinely stored in filing cabinets.

One particular type of filing cabinet provides for storage of hanging file folders where the hanging file folders include tabs that lie over rails within the filing cabinet. Hanging file folders offer several advantages over ordinary file folders. For example, hanging file folders, because they glide on a rail, are easier to move back and forth in a filing cabinet than are regular file folders thereby allowing a person to more quickly locate a particular file of interest. Additionally, because the hanging file folders hang from a rail in the filing cabinet, documents and other stored items are inhibited from becoming buried to deep within the file cabinet for a person to readily locate and remove.

However, despite the many advantages hanging file folders and cabinets for storing such provide, hanging file folders still suffer from one significant drawback. There is a propensity for hanging file folders to “fall off” of the guide rail within the filing cabinet. When this occurs, many of the advantages that hanging file folders provide over other types of file folders is lost. Documents may then become lost in the deep somewhat unreachable recesses of the filing cabinet and the ability to quickly and easily move file folders around in the filing cabinet in order to locate a particular file is lost.

### SUMMARY OF THE INVENTION

The present invention presents the rare opportunity to create an entirely new hanging file folder retainer that provides a solution to the disadvantages, limitations, and problems mentioned above. Thus, from the foregoing it may be appreciated that a need has arisen for a hanging file folder retainer in which hanging file folders are inhibited from falling off of the guide rail but that still provides access to the file folders allowing their removal from and insertion into the filing cabinet as needed.

According to one aspect of the invention, a hanging file folder retainer is provided that includes, in one embodiment, a first attaching member, a second attaching member, and a retaining member. The first and second attaching members couple to a hanging file drawer rail in order to secure the hanging file folder retainer to the hanging file drawer rail. The second attaching member is linearly disposed from the first attaching member such that the hanging file folder retainer is secured to the hanging file drawer rail in at least two locations. The retaining member has a length sufficient to at least span the distance between said first and second attaching members and is functionally coupled to the first and second attaching member such that, in at least one functional position, the retaining member inhibits hanging file tabs from disengaging from the hanging file drawer rail.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like parts, in which:

FIG. 1 is an exemplary hanging file cabinet in which the present invention may be implemented;

FIG. 2 is an exemplary file drawer for hanging file folders in which a hanging file folder retainer may be implemented in accordance with one embodiment of the present invention;

FIG. 3 is a more detailed view of an exemplary file drawer rail and an exemplary hanging file retainer in accordance with one embodiment of the present invention;

FIGS. 4A-4G show various views of an exemplary one piece snap on hanging file retainer in accordance with one embodiment of the present invention;

FIGS. 5A-5G show various views of an exemplary hanging file retainer with locking screws for securing the hanging file retainer to a file drawer rail in accordance with one embodiment of the present invention;

FIGS. 6A-6I show various views of an exemplary hanging file retainer with locking screws or double sided tape for securing the hanging file retainer to a file drawer rail and a pivoting retaining member with a molded pin lock for securing the retaining member closed in accordance with one embodiment of the present invention;

FIGS. 7A-7I show various views of an exemplary hanging file retainer with locking screws or double sided tape for securing the hanging file retainer to a file drawer rail and a pivoting retaining member with a thumb screw for securing the retaining member closed in accordance with one embodiment of the present invention;

FIGS. 8A-8I show various views of an exemplary hanging file retainer with locking screws or double sided tape for securing the hanging file retainer to a file drawer rail and a pivoting retaining member with a hook and loop connector for securing the retaining member closed in accordance with one embodiment of the present invention;

FIGS. 9A-9H show various views of an exemplary hanging file retainer with locking screws or double sided tape for securing the hanging file retainer to a file drawer rail and a removable retaining member with pin locks for securing the retaining member closed in accordance with one embodiment of the present invention;

FIGS. 10A-10H show various views of an exemplary hanging file retainer with locking screws or double sided tape for securing the hanging file retainer to a file drawer rail and a removable retaining member with thumb screws for securing the retaining member closed in accordance with one embodiment of the present invention;

FIGS. 11A-11H show various views of an exemplary hanging file retainer with locking screws or double sided tape for securing the hanging file retainer to a file drawer rail and a removable retaining member with hook and loop connector for securing the retaining member closed in accordance with one embodiment of the present invention;

FIGS. 12A-12H show various views of an exemplary hanging file retainer with locking screws or double sided tape for securing the hanging file retainer to a file drawer rail and a hinged retaining member with a hook and loop connector for securing the retaining member closed in accordance with one embodiment of the present invention; and

FIGS. 13A-13H show various views of an exemplary hanging file retainer with locking screws or double sided tape for securing the hanging file retainer to a file drawer rail and a hinged retaining member with magnets for securing the retaining member closed in accordance with one embodiment of the present invention.

### DETAILED DESCRIPTION OF THE INVENTION

It should be understood at the outset that although an exemplary implementation of the present invention is illustrated below, the present invention may be implemented using any number of techniques, whether currently known or in existence. The present invention should in no way be limited to the exemplary implementations, drawings, and techniques illustrated below, including the exemplary design and implementation illustrated and described herein. Like reference numerals refer to like elements throughout the description. Additionally, the drawings contained herein are not necessarily drawn to scale.

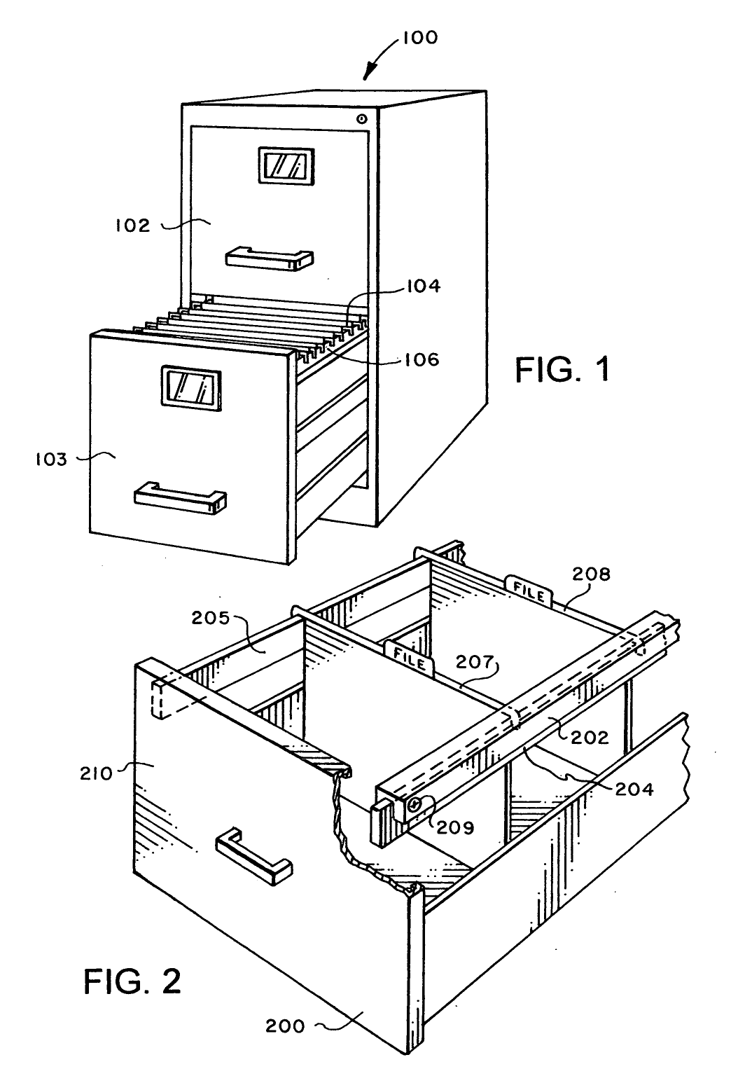

With reference now to the figures, and in particular with reference to FIG. 1, an exemplary hanging file cabinet is shown in which the present invention may be implemented. File cabinet 100 includes two file drawers 102-103. Guide rails 106 are provided within the file drawers 102-103 in which to hang hanging file folders 104.

File cabinet 100 is presented merely as an example of a file cabinet. Those skilled in the art will recognize that the present invention may be utilized with many different types of file cabinets including, for example, those with more or fewer file drawers as well as lateral file cabinets. As such, the present invention is not limited to use with any one type of file cabinet.

With reference now to FIG. 2, an exemplary file drawer for hanging file folders in which a hanging file folder retainer may be implemented in accordance with one embodiment of the present invention is shown. File drawer 200 is an example of a file drawer that may be implemented as, for example, any of file drawers 102-103 depicted in FIG. 1. File drawer 200 includes file drawer rails 204-205 on which the tab portion of hanging file folders 207-208 may rest thereby allowing the hanging file folders 207-208 to hang in the file drawer 200.

A hanging file retainer 202 is attached to file drawer rail 204 thereby inhibiting or preventing the tabs for hanging file folders 207-208 from disengaging from the file drawer rail 204. In the depicted example, the hanging file retainer 202 fits over the file drawer rail 204 as indicated and is locked into place over the file drawer rail 204 by a locking screw 209 thereby preventing the hanging file retainer 202 from being accidentally knocked off of the file drawer rail 204. If a hanging file folder 207-208 needs to be removed or replace or if a new hanging file folder needs to be inserted into file drawer 200, the hanging file retainer may be removed by unscrewing the lock screw 209 and removing the hanging file retainer 202. Although not depicted in FIG. 2, a hanging file retainer, such as, for example, hanging file retainer 202, may be attached to file drawer rail 205 as well.

Although not depicted, the hanging file retainer 202 typically also includes a attaching and locking mechanism at the opposite end from screw 209 which, in the depicted example, would be located in the file drawer 200 in a spot farther from the front 210 of the file drawer 200 than screw 209. It should be noted that hanging file retainer 202 depicted in FIG. 2 is but one example of a hanging file retainer 202 that may be utilized to prevent or inhibit disengagement of hanging file folder tabs from a file drawer rail and is provided merely in order to illustrate one method of how a hanging file retainer may fit over a file drawer rail and prevent or inhibit disengagement of the hanging file folder tabs form the file drawer rail. Many other embodiments are possible, some of which are described below in order to better explain and illustrate the hanging file retainer of the present invention.

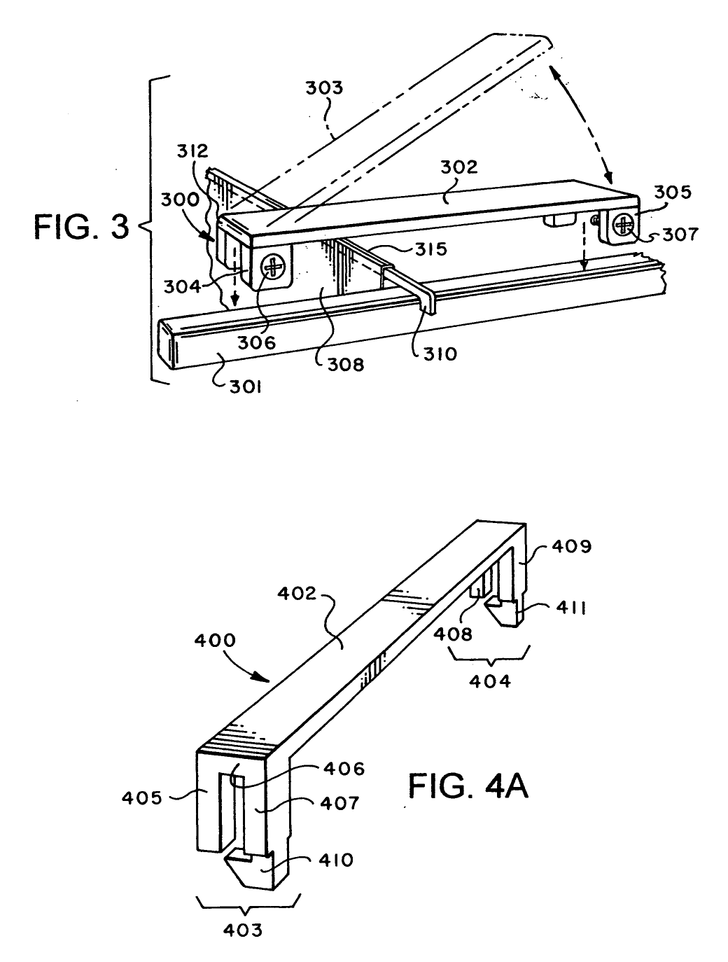

With reference now to FIG. 3, a more detailed view of an exemplary file drawer rail and an exemplary hanging file retainer is shown in accordance with one embodiment of the present invention. File drawer rail 301 is an example of a file drawer rail for use in a file cabinet, such as, for example, file drawer rail 204 in file drawer 200 depicted in FIG. 2. File drawer rail 301 is configured such that a hanger 315 of a hanging file folder 308 may rest on the file drawer rail 304 with the tab 310 extending down over the outside of the file drawer rail 301 such that the hanging file folder 308 may hang within a file drawer from the file drawer rail 304 as depicted in FIG. 3.

A hanging file retainer 300 may be placed over file drawer rail 301 such that the tab 310 is constrained to remain resting over the outside of the file drawer rail 301 thereby inhibiting or preventing the hanging file folder 308 from being removed from the file drawer or from dropping off of the file drawer rail 301 and becoming lost in the bottom of the file drawer.

Hanging file retainer 300 includes two attaching members 304 and 305 by which the hanging file retainer 300 is attached to the file drawer rail 301. Hanging file retainer 300 also includes a retaining member 302 that spans the distance between attaching members 304-305 and is configured that in a locked position, the retaining member 302 is situated sufficiently close to the file drawer rail 301 such that the hanging file folder 308 may not be raised sufficiently that the tab 310 can move away from the outside part of the file drawer rail 301. In many embodiments, the attaching members 304-305 and the retaining member 302 are fabricated from semi-rigid thermoplastic. However, many other materials may be used as well as those skilled in the art will recognize.

Typically, the distance between the file drawer rail 301 and retaining member 302 is sufficient that movement of the hanger 315 back and forth along the file drawer rail 301 is not significantly impeded, but is less than the distance that the tab 310 extends down over the file drawer rail 301 so that in no instance may the hanging file folder 308 be removed from or fall off of the file drawer rail 301.

In the depicted example, the hanging file retainer 300 is secured to the file drawer rail 301 by turning locking screws 306-307 sufficiently to secure the attaching members 304-305 to the file drawer rail 301 once the hanging file retainer's 300 attaching members 304-305 have been placed over the file drawer rail 301. The attaching members 304-305, in many embodiments, are generally three sided such that they surround three sides of the file drawer rail 301. In one embodiment, the cross-section of the attaching members is “U” shaped. Also as depicted in FIG. 3, the retaining member 302 may pivot about a pivot axis 312 to an open position 303 allowing file folders to be removed or added. In the closed position, the retaining member 303 locks into place to secure the hanging file folders 308. Those skilled in the art will recognize that various mechanisms may be utilized to lock the retaining member 303 into a closed position.

Hanging file retainer 300 is presented as an example of one embodiment of a hanging file retainer and is not meant to imply any architectural limitations to the present invention. Those skilled in the art will recognize many modifications and variations that may be applied to the depicted hanging file retainer 300 without from the scope and spirit of the present invention. For example, other embodiments may include a retaining member that does not pivot and may include other means for securing the hanging file retainer 300 to the file drawer rail 301 rather than the screws 306-307 depicted in FIG. 3. Examples of several embodiments for a hanging file retainer are described below.

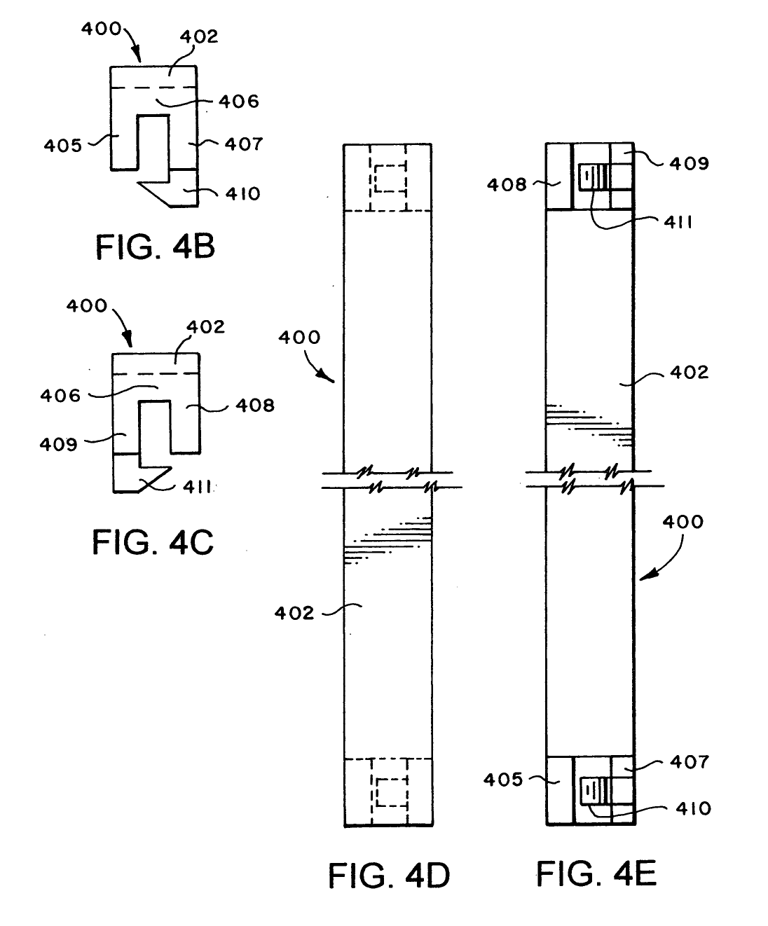

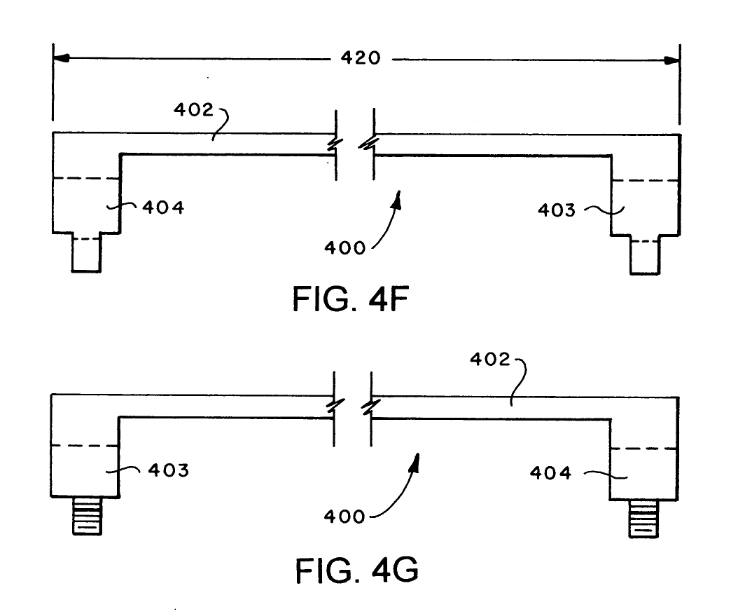

With reference now to FIGS. 4A-4G, various views of an exemplary one piece snap on hanging file retainer are shown in accordance with one embodiment of the present invention. FIG. 4A provides a perspective view of an exemplary one piece snap on hanging file retainer 400 in accordance with one embodiment of the present invention. FIGS. 4B and 4C illustrate end views of hanging file retainer 400 for one embodiment of hanging file retainer 400. FIGS. 4D and 4E illustrate top and bottom views, respectively, of hanging file retainer 400. FIGS. 4F and 4G illustrate front and back views, respectively, of the side of hanging file retainer 400.

In this embodiment, hanging file retainer 400 comprises a continuous material and includes two attaching members 403-404 and a retaining member 402. The length 420 of the retaining member 402 varies depending on implementation. Of course, for any particular implementation, the length 420 may not be longer than the depth of the file drawer. Lengths 420 that are shorter than the length of the file drawer rail are possible in some implementations. Also, in some embodiments, retaining member 402 may extend past one or both of attaching members 403 and 404.

Each attaching member 403-404 includes a first vertical attaching member 405 or 408, a second vertical attaching member 407 or 409, and a top attaching member 406 (top attaching member for attaching member 404 is not visible). Each attaching member 403-404 also includes a clip member 410 and 411 that clips beneath a file drawer rail such as, for example, file drawer rail 301 depicted in FIG. 3. The attaching member 403-404 are sufficiently flexible such that the first attaching member 405 or 408 may be moved away from the second vertical attaching member 407 or 409 that the clip member 410 may slip over the file drawer rail and clip beneath the file drawer rail.

Hanging file retainer 400 is typically used with file drawers in which the file drawer rail is a bar that extends across at least a portion of the file drawer but does not comprise a solid piece beneath the bar.

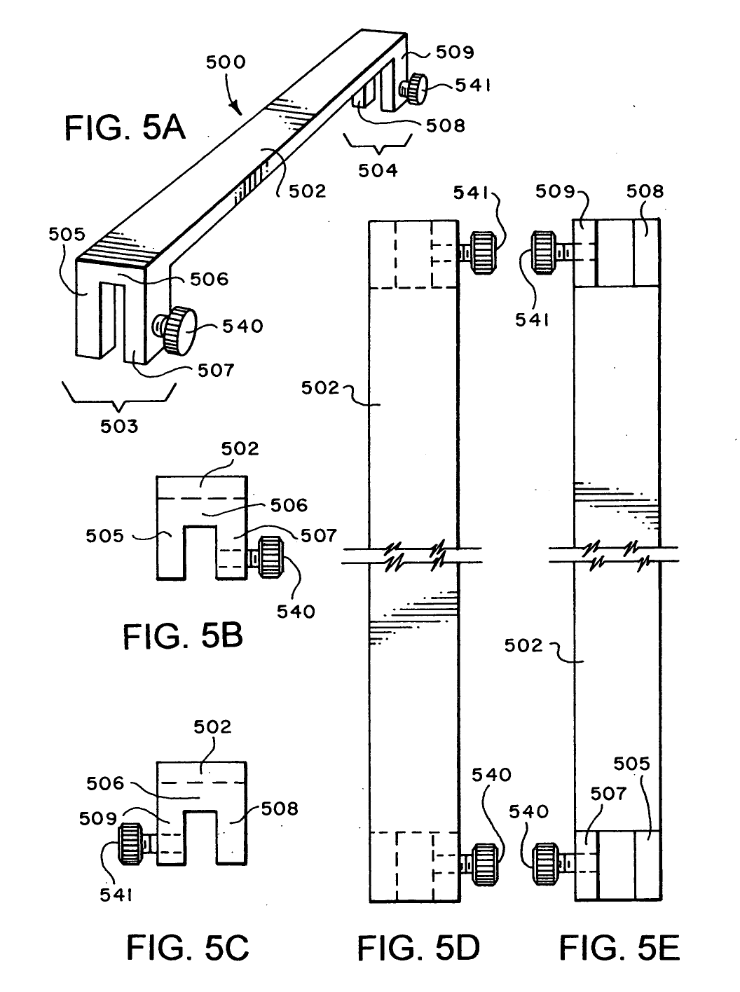

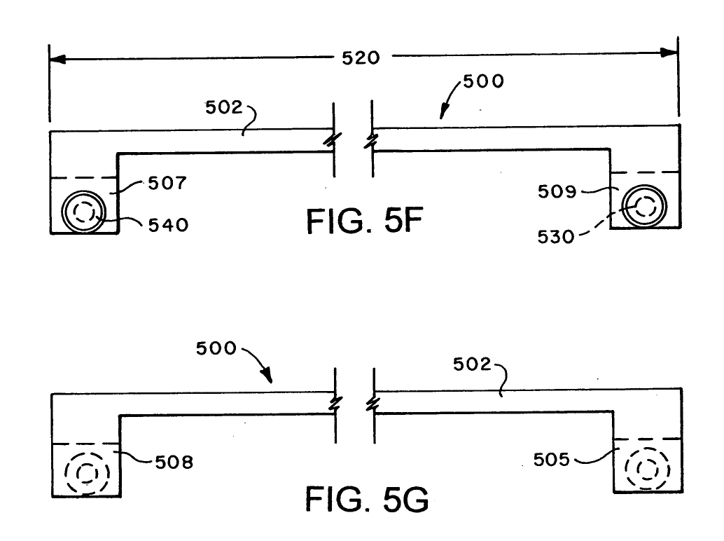

With reference now to FIGS. 5A-5G, various views of an exemplary hanging file retainer with locking screws for securing the hanging file retainer to a file drawer rail are shown in accordance with one embodiment of the present invention. FIG. 5A shows a perspective view of hanging file retainer 500 in accordance with one embodiment of the present invention. FIGS. 5B-5C show end views of hanging file retainer 500 in accordance with one embodiment of the present invention. FIGS. 5D and 5E show top and bottom views, respectively, of hanging file retainer 500. FIGS. 5F and 5G show front side and back side views, respectively, of hanging file retainer 500 and shows exemplary screw holes 530 and 540.

Hanging file retainer 500 is similar in many respects to hanging file retainer 400 depicted in FIG. 4. Hanging file retainer 500 comprises a continuous material and includes two attaching members 503-504 and a retaining member 502. The length 520 of the retaining member 502 varies depending on implementation. Of course, as stated above with reference to hanging file retainer 400, for any particular implementation, the length 520 may not be longer than the depth of the file drawer. Lengths 520 that are shorter than the length of the file drawer rail are possible in some implementations.

Each attaching member 503-504 includes a first vertical attaching member 505 or 508, a second vertical attaching member 507 or 509, and a top attaching member 506 (top attaching member for attaching member 504 is not visible). In contrast to hanging file retainer 400, rather than clips, hanging file retainer 500 includes locking screws 520 and 521 which may be tightened into screw holes 530 and 540 once the hanging file retainer 500 has been appropriately located thereby securing hanging file retainer 500 to a file drawer rail. Further in contrast to file retainer 400, file retainer 500 may be utilized with file drawer rails that extend vertically as a solid sheet from the top of the file drawer rail over which the hanging file retainer 500 is placed down toward the bottom of the file drawer. File retainer 500 may also be utilized with file drawer rails that are merely bars, without a solid piece beneath, spanning at least a portion of the file drawer as long as the file drawer rail is sufficiently thick vertically such that that the tightening screws 520 and 521 will contact a portion of the file drawer rail when tightened.

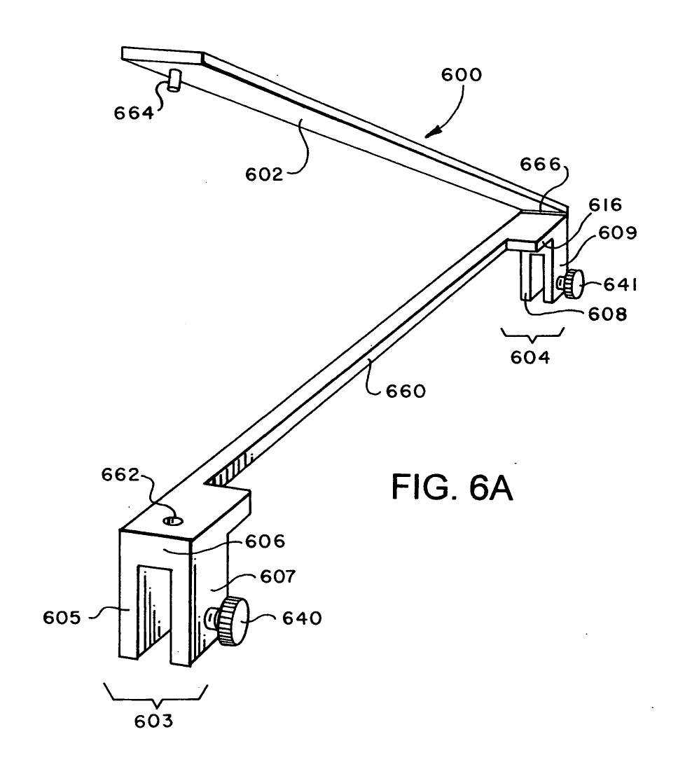

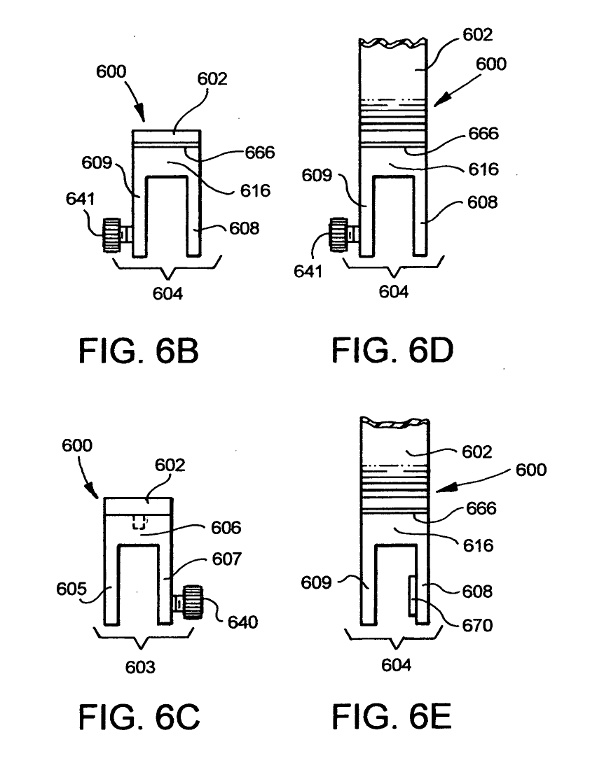

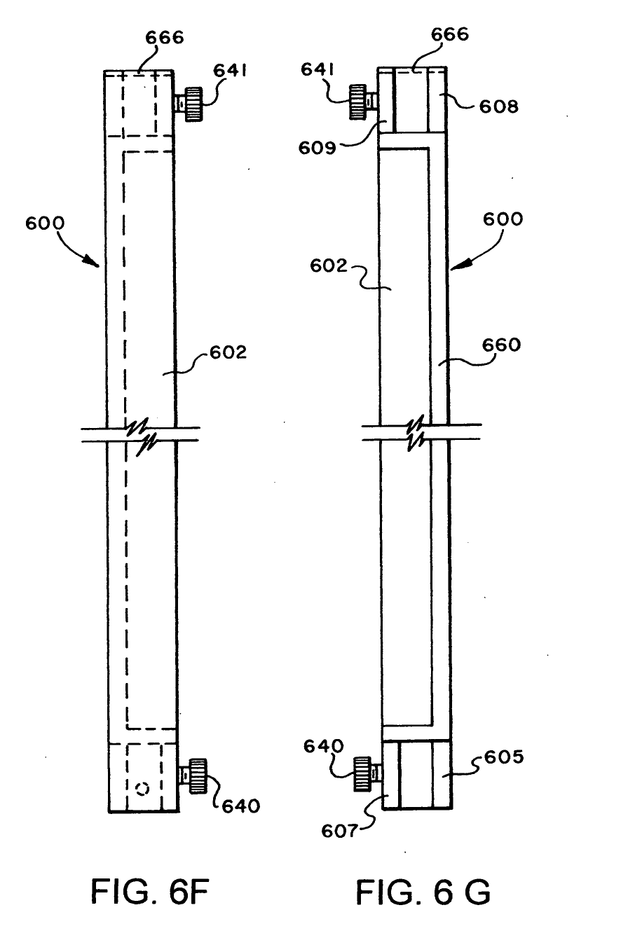

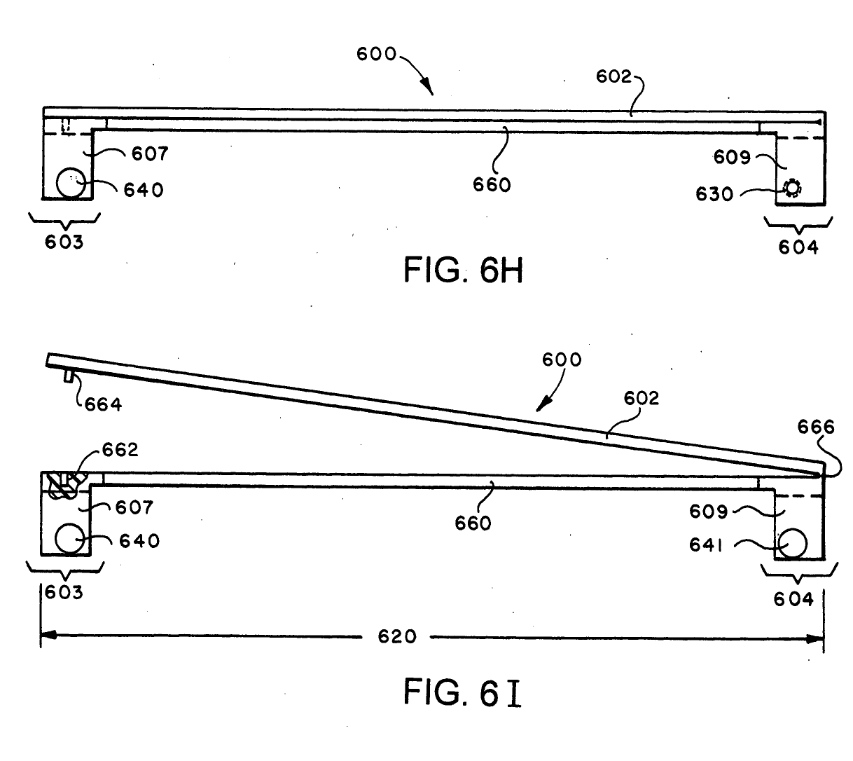

With reference now to FIGS. 6A-61, various views of an exemplary hanging file retainer with locking screws or double sided tape for securing the hanging file retainer to a file drawer rail and a pivoting retaining member with a molded pin lock for securing the retaining member closed are shown in accordance with one embodiment of the present invention. FIG. 6A shows a perspective view of hanging file retainer 600 in accordance with one embodiment of the present invention. FIG. 6B shows the hinged end of hanging file retainer 600 in a closed position in accordance with one embodiment of the present invention. FIG. 6C shows the lock end of the hanging file retainer 600 in a closed position in accordance with one embodiment of the present invention. FIG. 6D shows the hinged end of hanging file retainer 600 in an open position in accordance with one embodiment of the present invention. FIG. 6E shows the hinged end of the hanging file retainer 600 in an open position and showing alternative double-stick tape 670 mounting rather than screw 640 or 641 mounting in accordance with one embodiment of the present invention. FIGS. 6F and 6G show top and bottom views respectively of hanging file retainer 600 in accordance with one embodiment of the present invention. Figures 6H and 6I show side open and side closed views of hanging file retainer 600 in accordance with one embodiment of the present invention.

Hanging file retainer 600 includes two attaching members 603-604, a linking member 660, and a pivoting retaining member 602. The length 620 of the hanging file retainer 600 varies depending on implementation. Each attaching member 603-604 includes a first vertical attaching member 605 or 608, a second vertical attaching member 607 or 609, and a top attaching member 606 or 616. Hanging file retainer 600, in one embodiment, includes locking screws 620 and 621 which may be tightened once the hanging file retainer 600 has been appropriately located thereby securing hanging file retainer 600 to a file drawer rail. Linking member 660 connects attaching member 603 to attaching member 604.

Pivoting retaining member 602 pivots about a pivot axis 666 between open and closed positions. When the pivoting retaining member 602 is in the closed position, and the hanging file retainer 600 is secured to a file drawer rail, hanging file folders are restricted to hanging from the file drawer rail and are prevented or inhibited from falling from the rail or being removed from the rail. Pivoting retaining member 602 is locked or secured closed by a molded pin lock that may be inserted into pin lock receptacle 662 in attaching member 603. When the pivoting retaining member 602 is in the open position, hanging file folders may be removed from or added into the file drawer. Linking member 660 is located on the opposite side of the file drawer rail from the location of the hanging file folders. Thus, linking member 660 is positioned such that it does not interfere with movement of the hanging file folders along the file drawer and does not hinder removal or placement of hanging files within the file drawer.

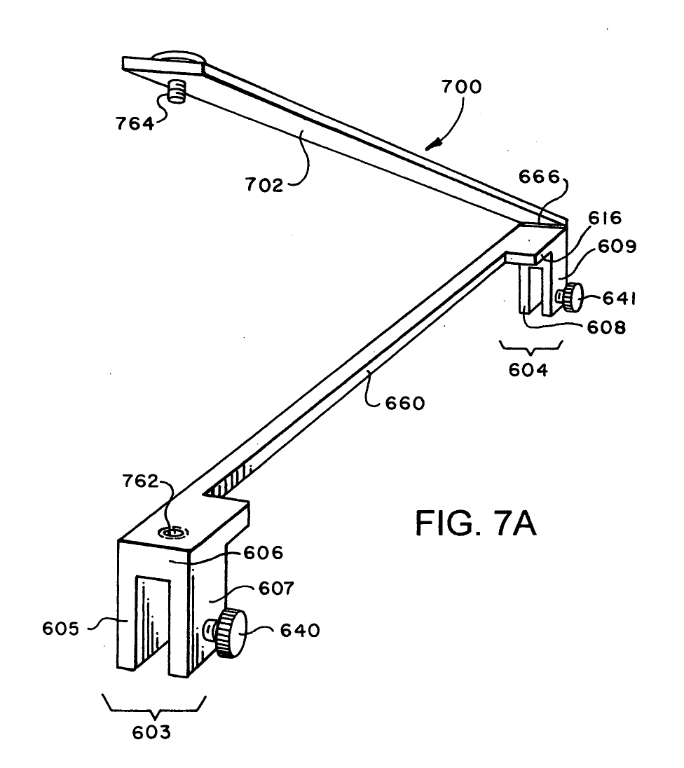

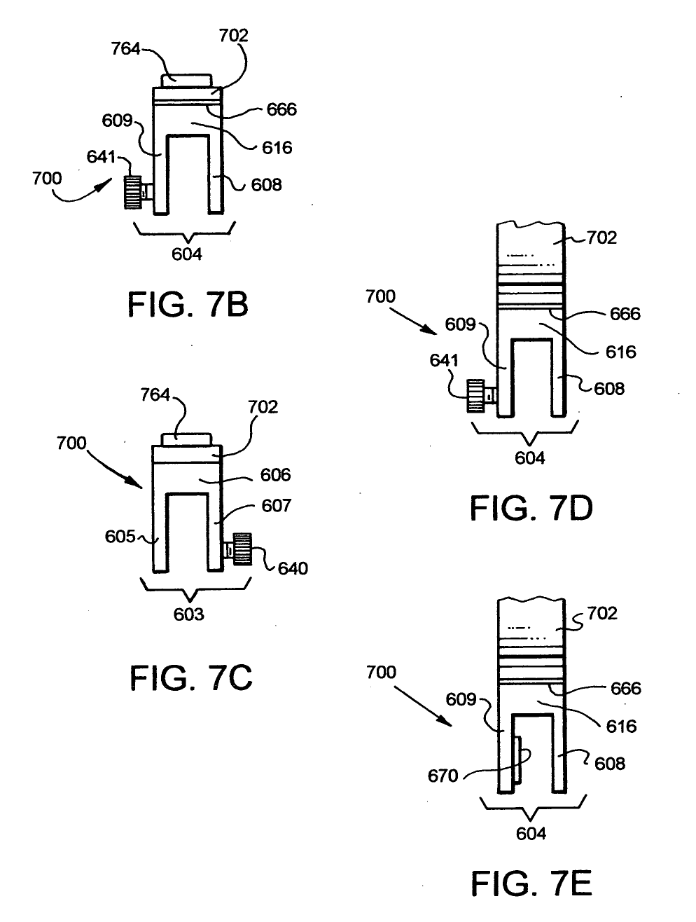

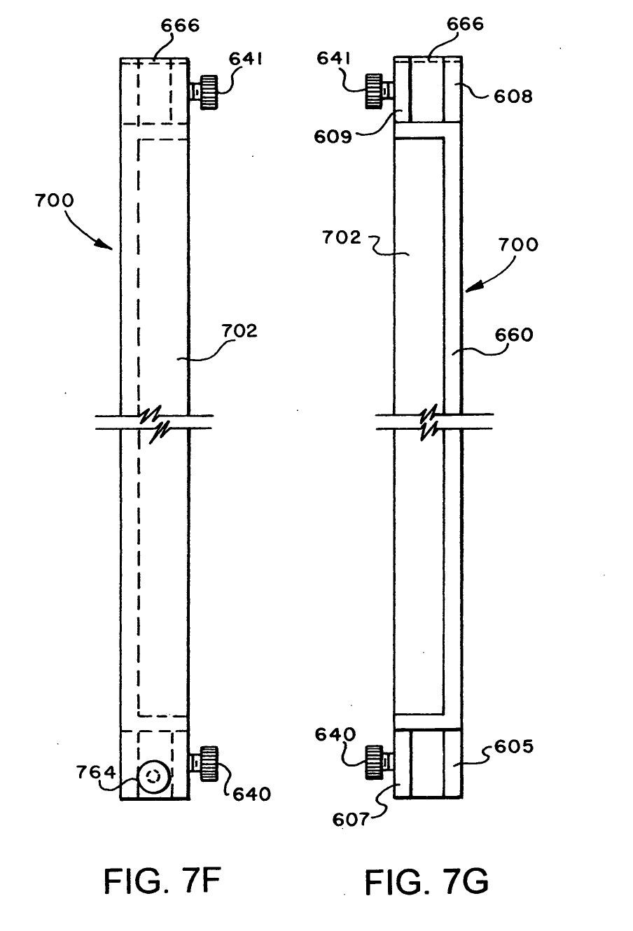

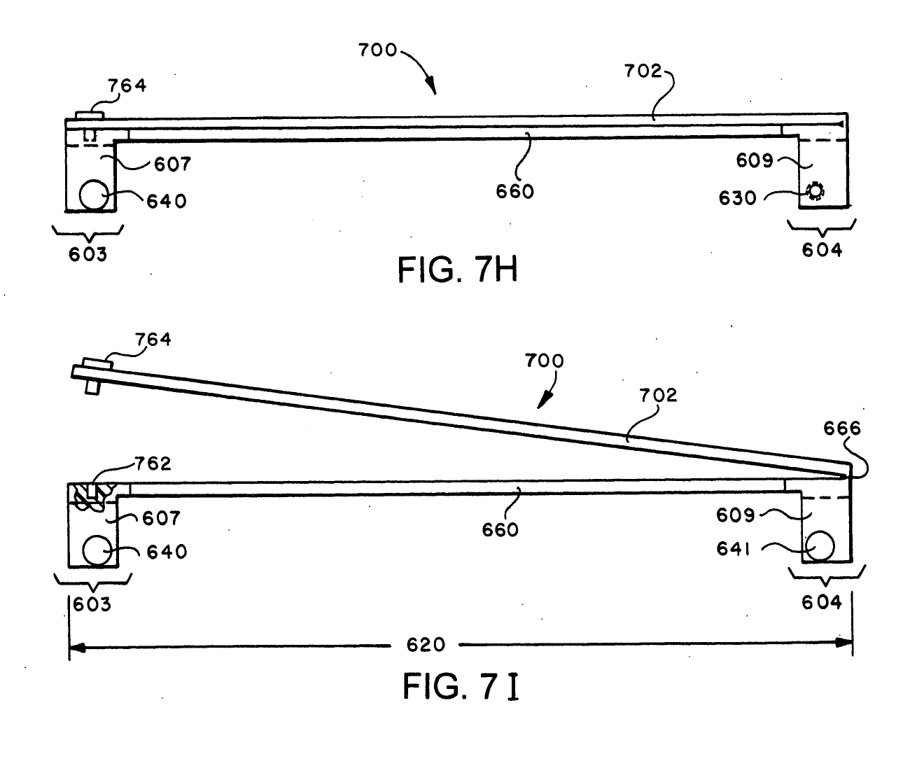

With reference now to FIGS. 7A-7I, various views of an exemplary hanging file retainer with locking screws or double sided tape for securing the hanging file retainer to a file drawer rail and a pivoting retaining member with a thumb screw 764 for securing the retaining member closed are shown in accordance with one embodiment of the present invention. FIG. 7A shows a perspective view of hanging file retainer 700 in accordance with one embodiment of the present invention. FIG. 7B shows the hinged end of hanging file retainer 700 in a closed position in accordance with one embodiment of the present invention. FIG. 7C shows the lock end of the hanging file retainer 700 in a closed position in accordance with one embodiment of the present invention. FIG. 7D shows the hinged end of hanging file retainer 700 in an open position in accordance with one embodiment of the present invention. FIG. 7E shows the hinged end of the hanging file retainer 700 in an open position and showing alternative double-stick tape 670 mounting rather than screw mounting 641 or 640 in accordance with one embodiment of the present invention. FIGS. 7F and 7G show top and bottom views respectively of hanging file retainer 600 in accordance with one embodiment of the present invention. FIGS. 7H and 7I show side open and side closed views of hanging file retainer 700 in accordance with one embodiment of the present invention.

Hanging file retainer 700 is virtually identical to hanging file retainer 600 except for the mechanism for locking the pivoting retaining member 702 closed. In this embodiment, a thumb screw 764 is threaded through a hole in pivoting retaining member 702 and may be screwed into threaded receptacle 762 in attaching member 603.

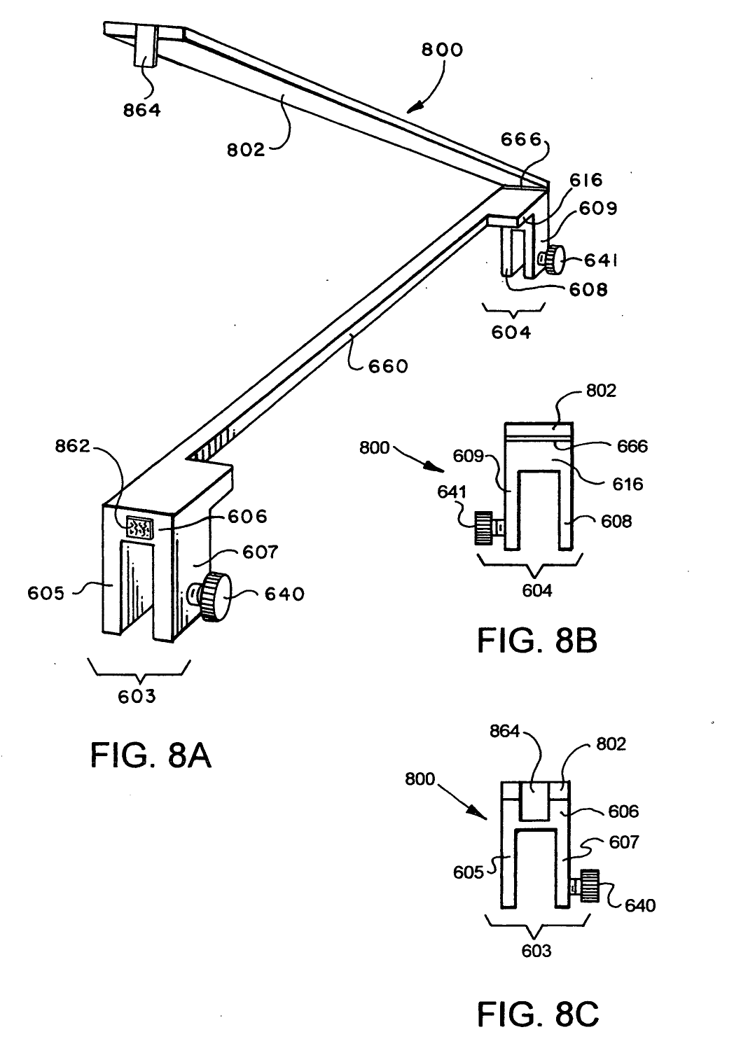

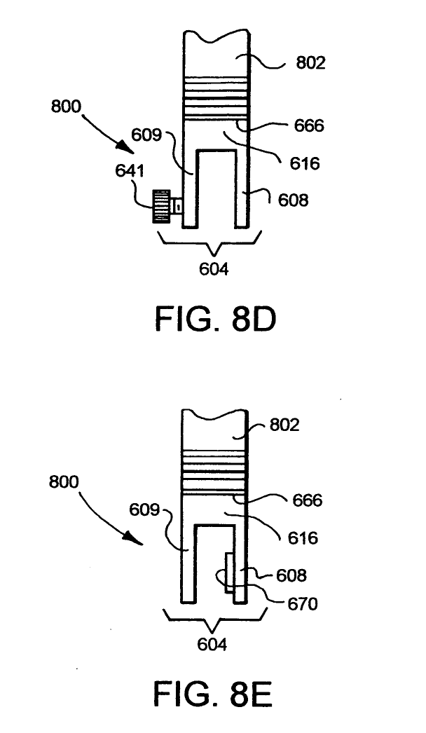

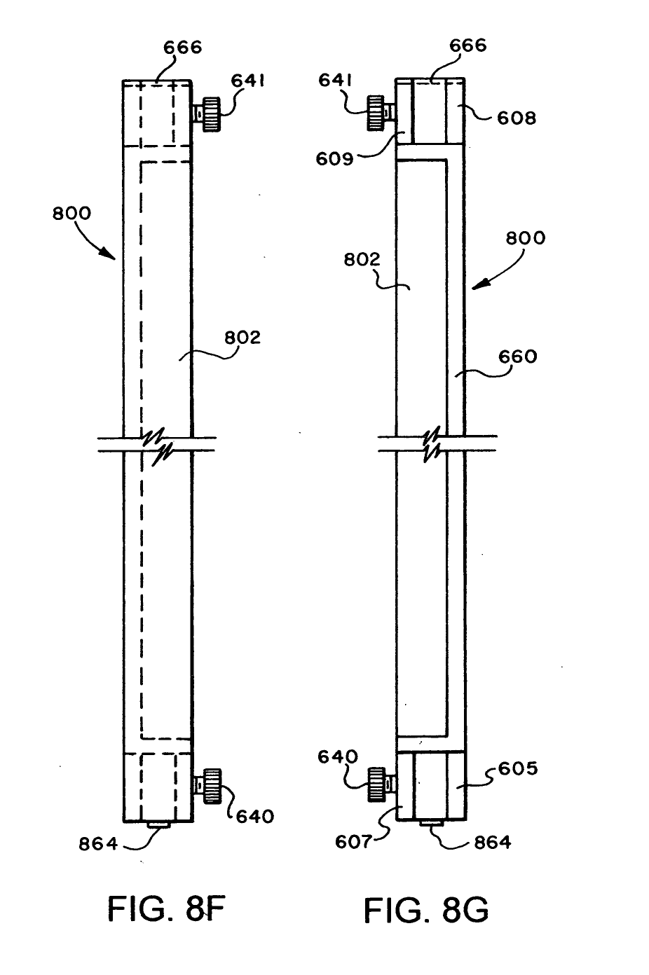

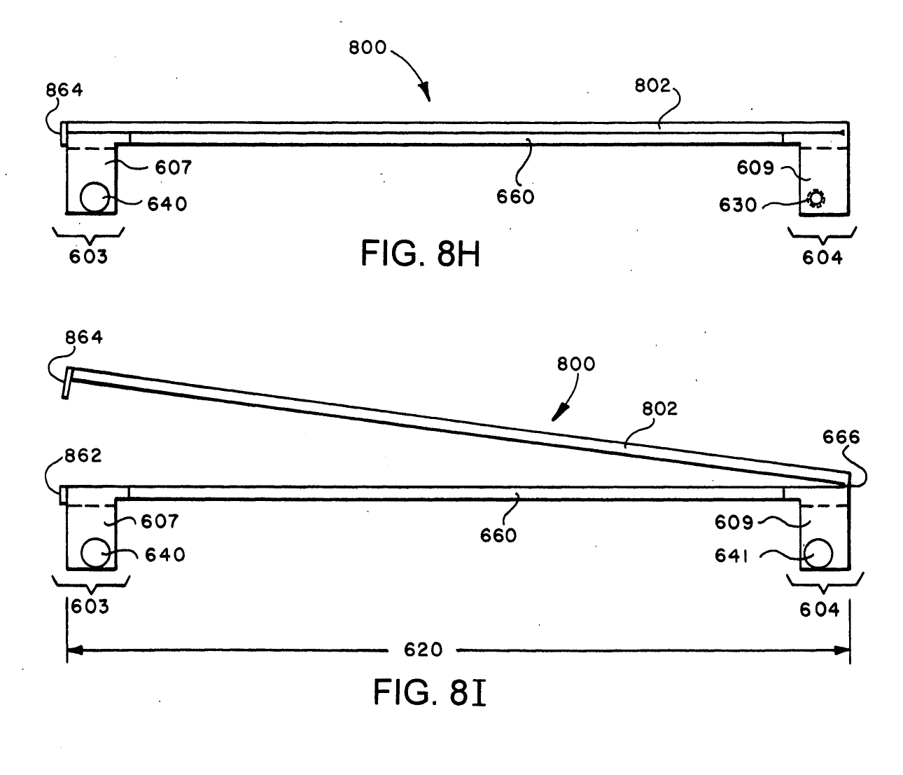

With reference now to FIGS. 8A-8I, various views of an exemplary hanging file retainer with locking screws or double sided tape for securing the hanging file retainer to a file drawer rail and a pivoting retaining member with a hook and loop connector, such as, for example, Velcro, for securing the retaining member closed are shown in accordance with one embodiment of the present invention. Velcro is a product and registered trademark of Velcro USA, Inc. of Manchester, New Hampshire. FIG. 8A shows a perspective view of hanging file retainer 800 in accordance with one embodiment of the present invention. FIG. 8B shows the hinged end of hanging file retainer 800 in a closed position in accordance with one embodiment of the present invention. FIG. 8C shows the lock end of the hanging file retainer 800 in a closed position in accordance with one embodiment of the present invention. FIG. 8D shows the hinged end of hanging file retainer 800 in an open position in accordance with one embodiment of the present invention. FIG. 8E shows the hinged end of the hanging file retainer 800 in an open position and shows alternative double-stick tape 670 mounting rather than screw mounting 641 or 640 in accordance with one embodiment of the present invention. FIGS. 8F and 8G show top and bottom views respectively of hanging file retainer 800 in accordance with one embodiment of the present invention. FIGS. 8H and 8I show side open and side closed views of hanging file retainer 800 in accordance with one embodiment of the present invention.

Hanging file retainer 800 is virtually identical to hanging file retainer 600 except for the mechanism for locking the pivoting retaining member 802 closed. In this embodiment, Velcro 864, or other hook and loop connecting material, is attached to pivoting retaining member 802 and may be attached to a complimentary piece of Velcro 862 on attaching member 603 thereby securing the hanging file retainer 800 in a closed position preventing removal of hanging file folders.

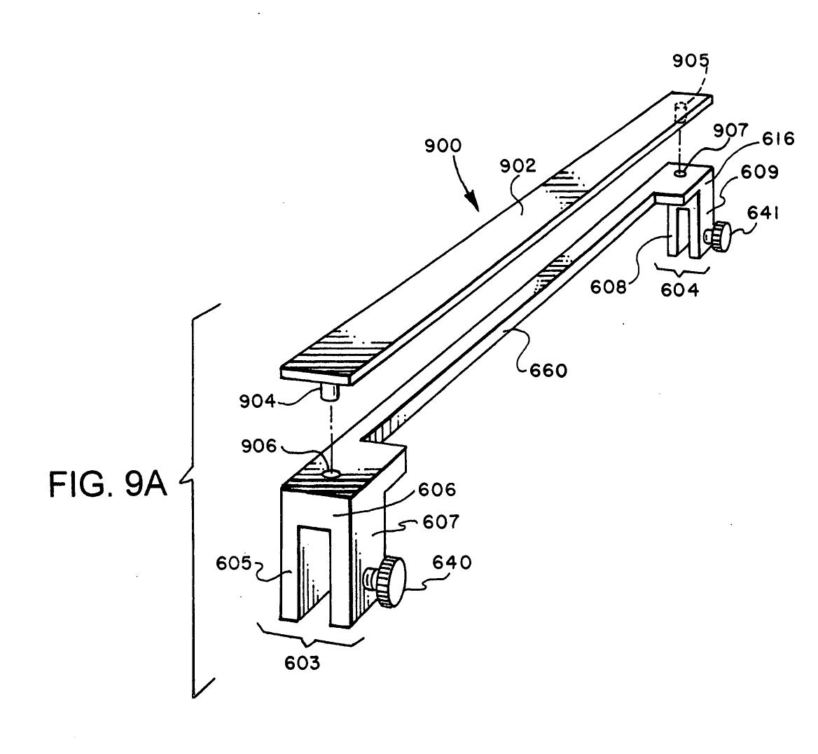

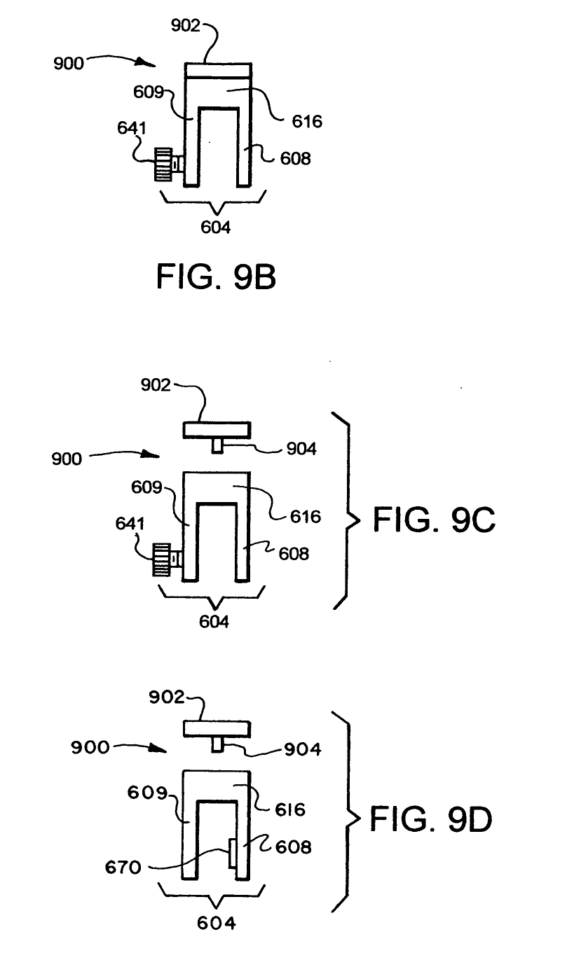

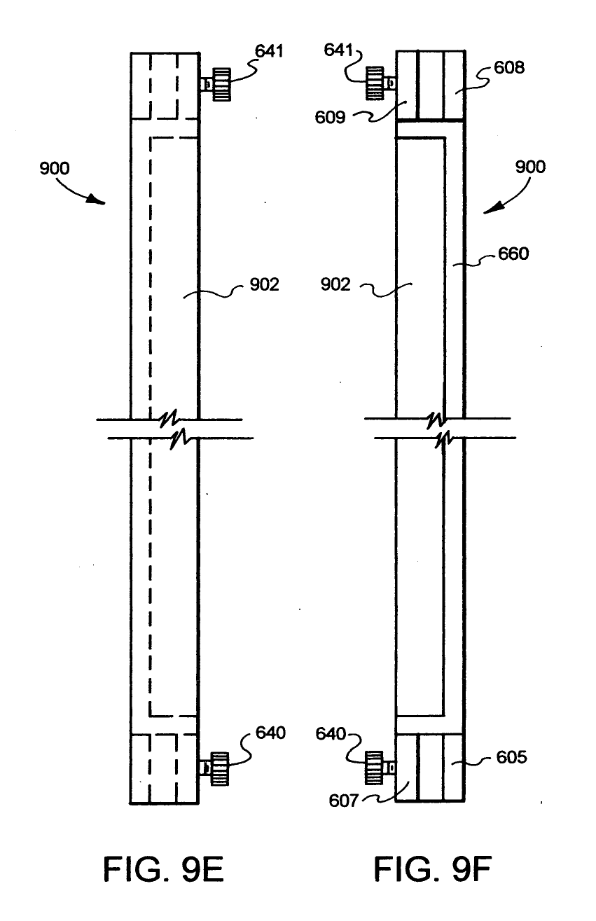

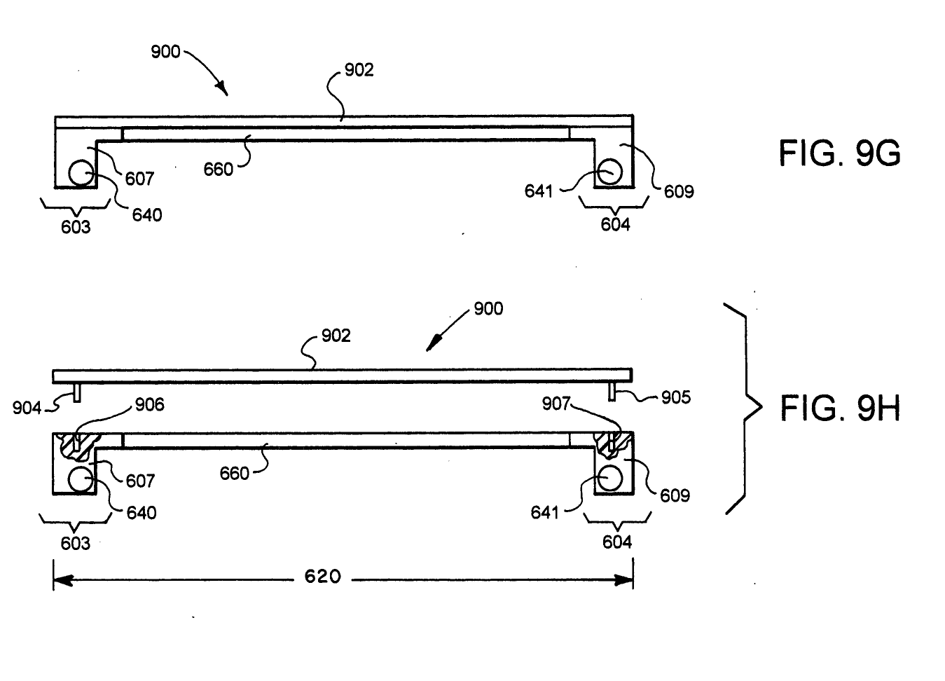

With reference now to FIGS. 9A-9H, various views of an exemplary hanging file retainer with locking screws or double sided tape for securing the hanging file retainer to a file drawer rail and a removable retaining member with pin locks for securing the retaining member closed are shown in accordance with one embodiment of the present invention. FIG. 9A shows a perspective view of hanging file retainer 900 in accordance with one embodiment of the present invention. FIG. 9B shows an end of hanging file retainer 900 in a closed position in accordance with one embodiment of the present invention. FIG. 9C shows an end of the hanging file retainer 900 in an open position in accordance with one embodiment of the present invention. FIG. 9D shows an end of the hanging file retainer 900 in an open position and showing the alternative double-stick tape 670 mounting rather than screw mounting 641 or 640 for mounting the hanging file retainer 900 to a file drawer rail in accordance with one embodiment of the present invention. FIGS. 9E and 9F show top and bottom views respectively of hanging file retainer 900 in accordance with one embodiment of the present invention. FIGS. 9G and 9H show side open and side closed views of hanging file retainer 900 in accordance with one embodiment of the present invention.

Hanging file retainer 900 is virtually identical to hanging file retainer 600 except that rather than a pivoting retaining member 602, hanging file retainer 900 includes a removable retaining member 902. Retaining member 902 may be secured to the first and second attachment members 603-604 through insertion of molded pin locks 904 and 905 into respective ones of pin lock receptacles 906 and 907.

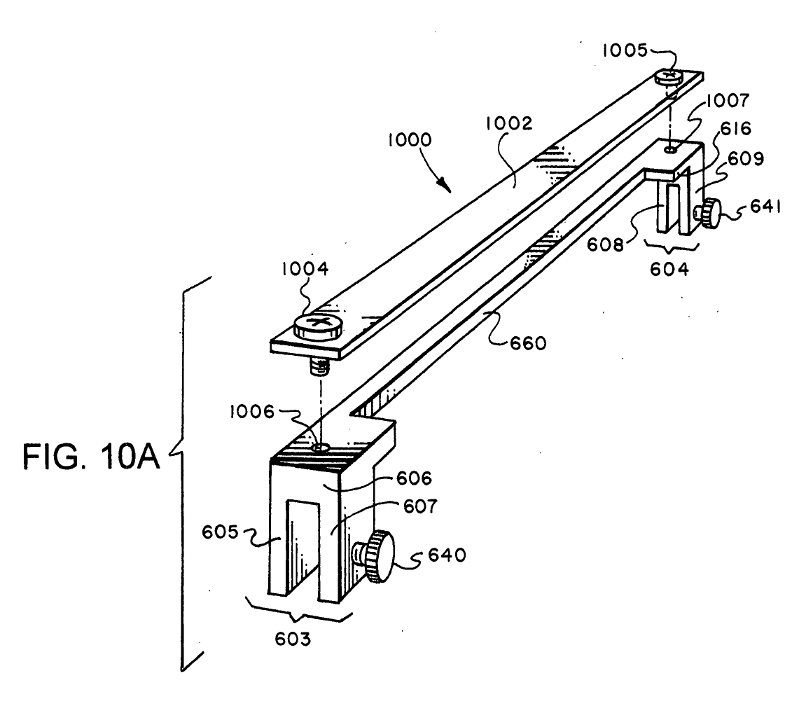

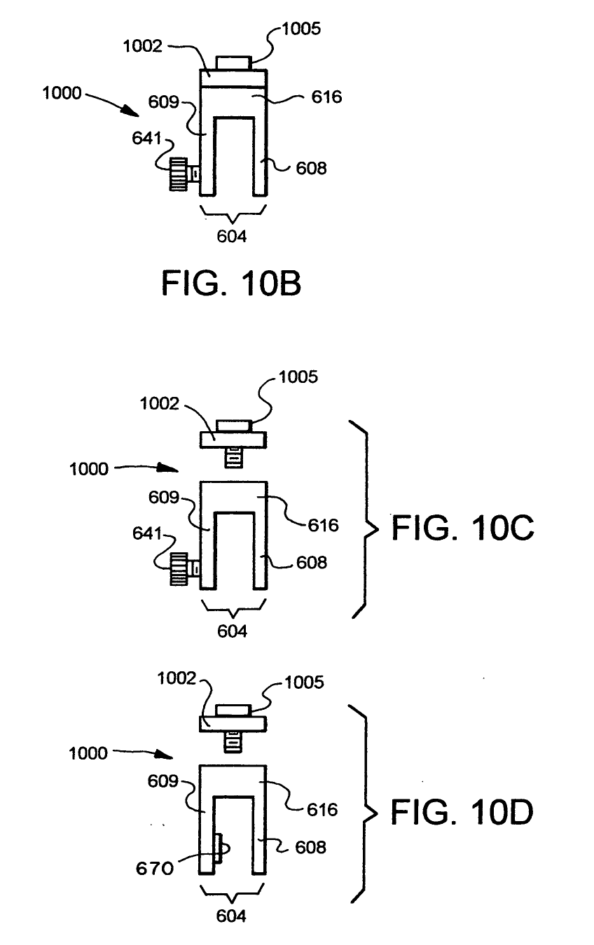

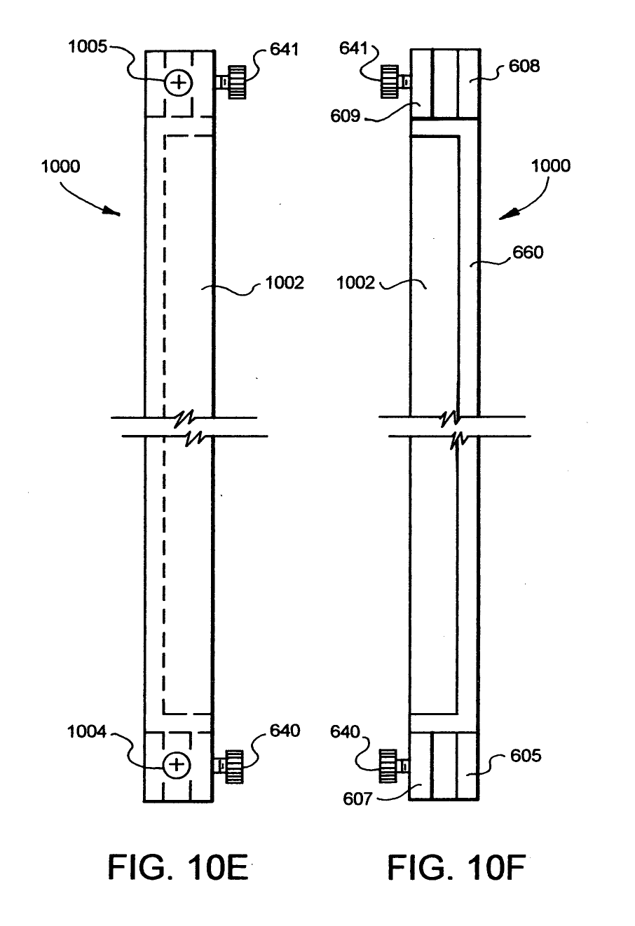

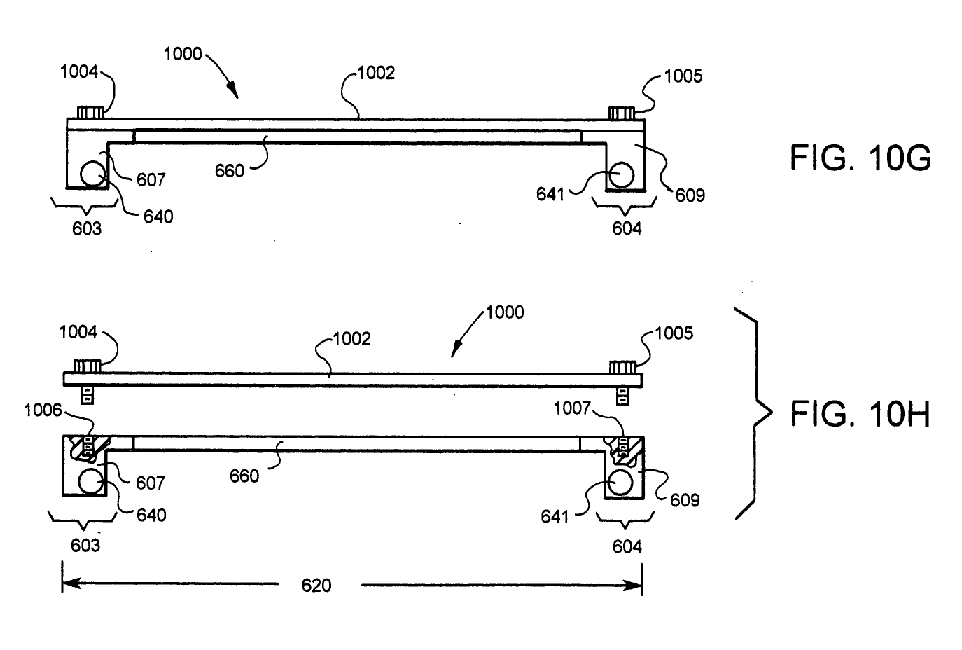

With reference now to FIGS. 10A-10H, various views of an exemplary hanging file retainer with locking screws or double sided tape for securing the hanging file retainer to a file drawer rail and a removable retaining member with thumb screws for securing the retaining member closed are shown in accordance with one embodiment of the present invention. FIG. 10A shows a perspective view of hanging file retainer 1000 in accordance with one embodiment of the present invention. FIG. 10B shows an end of hanging file retainer 1000 in a closed position in accordance with one embodiment of the present invention. FIG. 10C shows an end of the hanging file retainer 1000 in an open position in accordance with one embodiment of the present invention. FIG. 10D shows an end of the hanging file retainer 1000 in an open position and showing the alternative double-stick tape 670 mounting rather than screw mounting 641 or 640 for mounting the hanging file retainer 1000 to a file drawer rail in accordance with one embodiment of the present invention. FIGS. 10E and 10F show top and bottom views respectively of hanging file retainer 1000 in accordance with one embodiment of the present invention. FIGS. 10G and 10H show side open and side closed views of hanging file retainer 1000 in accordance with one embodiment of the present invention.

Hanging file retainer 1000 is virtually identical to hanging file retainer 900 except that rather than molded pin locks 904 and 905 for securing the retaining member 902 to the first and second attaching members 603 and 604, thumb screws 1004 and 1005 are used. Retaining member 1002 may be secured to the first and second attachment members 603-604 through insertion of thumb screws 1004 and 1005 through holes in retaining member 1002, threading thumb screws 1004 and 1005 into respective ones of threaded receptacles 1006 and 1007 and tightening.

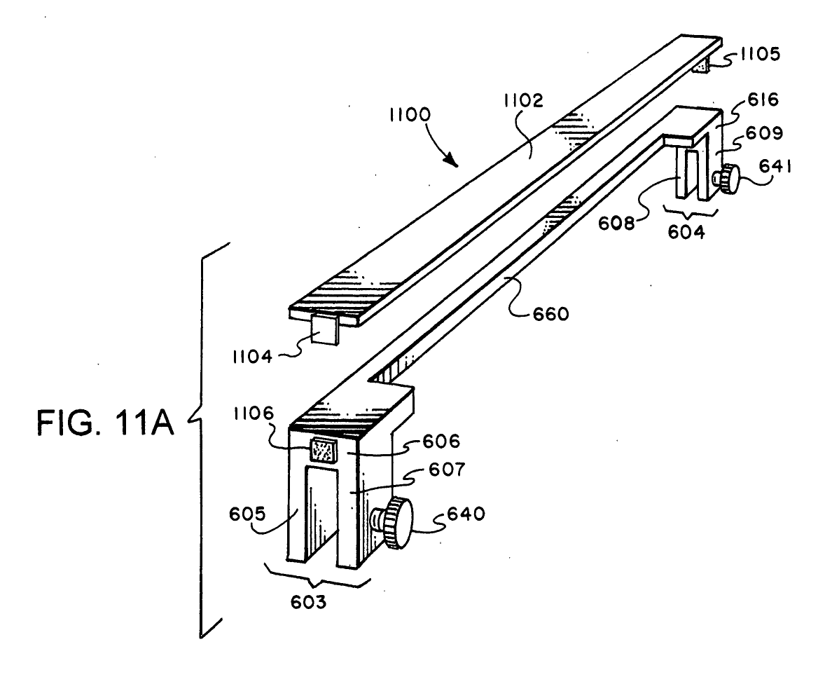

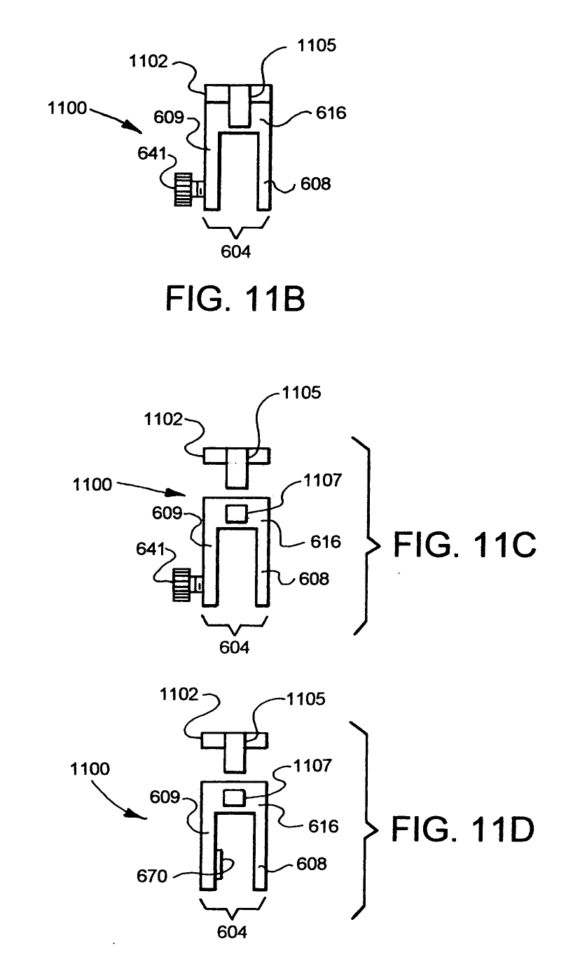

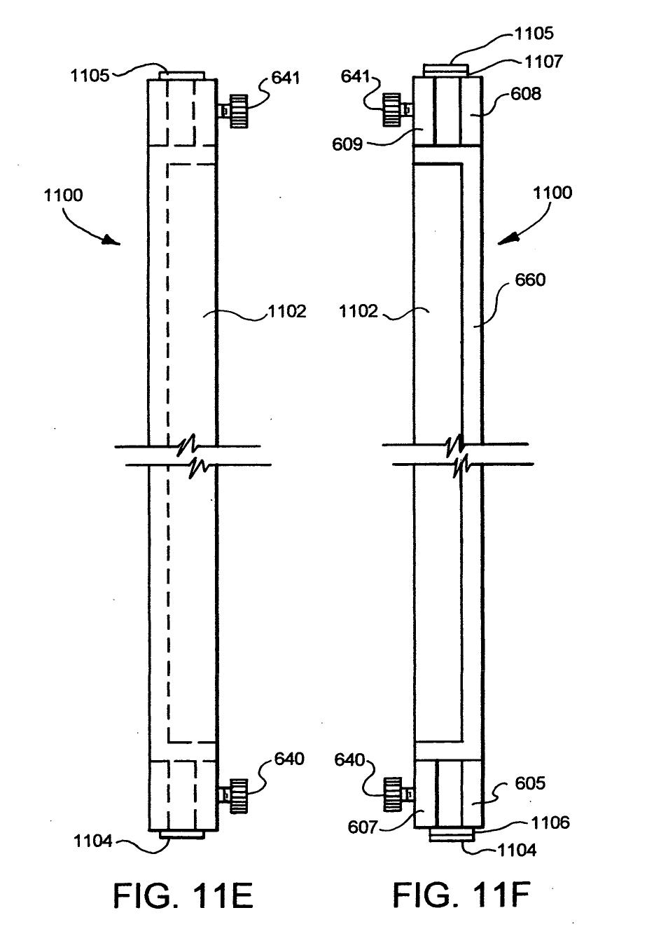

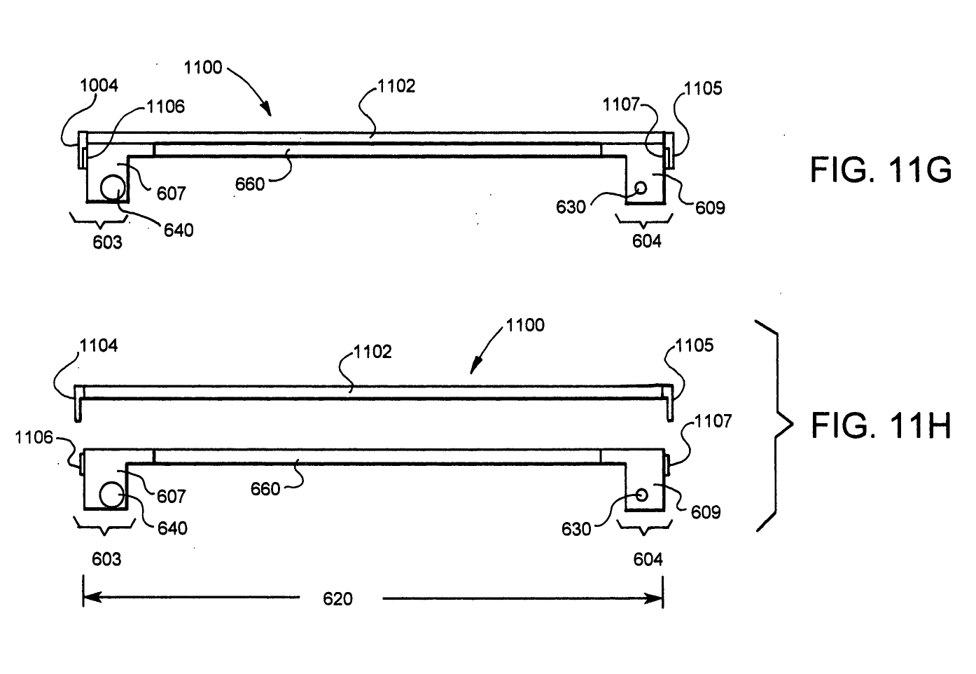

With reference now to FIGS. 11A-11H, various views of an exemplary hanging file retainer with locking screws or double sided tape for securing the hanging file retainer to a file drawer rail and a removable retaining member with Velcro for securing the retaining member closed are shown in accordance with one embodiment of the present invention. FIG. 11A shows a perspective view of hanging file retainer 1100 in accordance with one embodiment of the present invention. FIG. 11B shows an end of hanging file retainer 1100 in a closed position in accordance with one embodiment of the present invention. FIG. 11C shows an end of the hanging file retainer 1100 in an open position in accordance with one embodiment of the present invention. FIG. 11D shows an end of the hanging file retainer 1100 in an open position and showing the alternative double-stick tape 670 mounting rather than screw mounting 641 or 640 for mounting the hanging file retainer 1100 to a file drawer rail in accordance with one embodiment of the present invention. FIGS. 11E and 11F show top and bottom views respectively of hanging file retainer 1100 in accordance with one embodiment of the present invention. FIGS. 11G and 11H show side open and side closed views of hanging file retainer 1100 in accordance with one embodiment of the present invention.

Hanging file retainer 1100 is virtually identical to hanging file retainer 900 except that rather than molded pin locks 904 and 905 for securing the retaining member 902 to the first and second vertical attaching members 603 and 604, Velcro 1104-1106 is used. Retaining member 1102 may be secured to the first and second attachment members 603-604 through attaching Velcro pieces 1104 and 1105 on retaining member 1102 to respective complementary Velcro pieces 1106 and 1107 on respective ones of first and second attachment members 603 and 604.

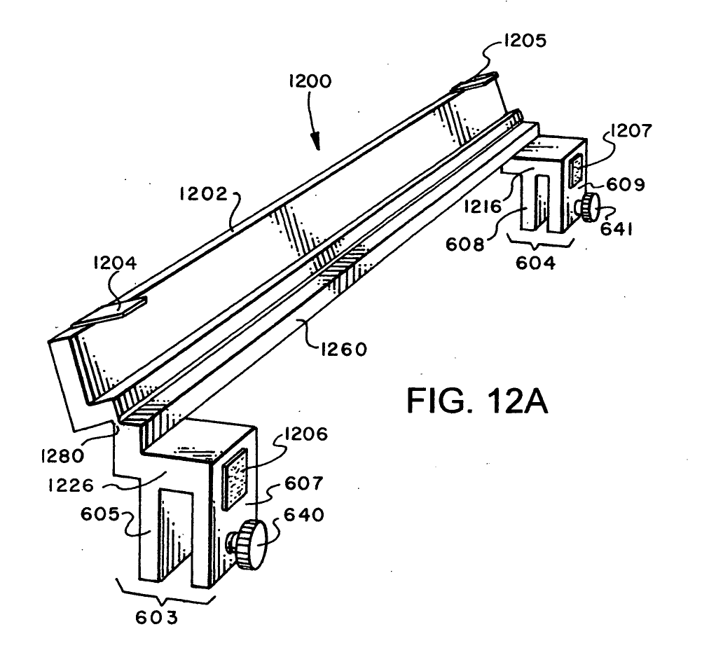

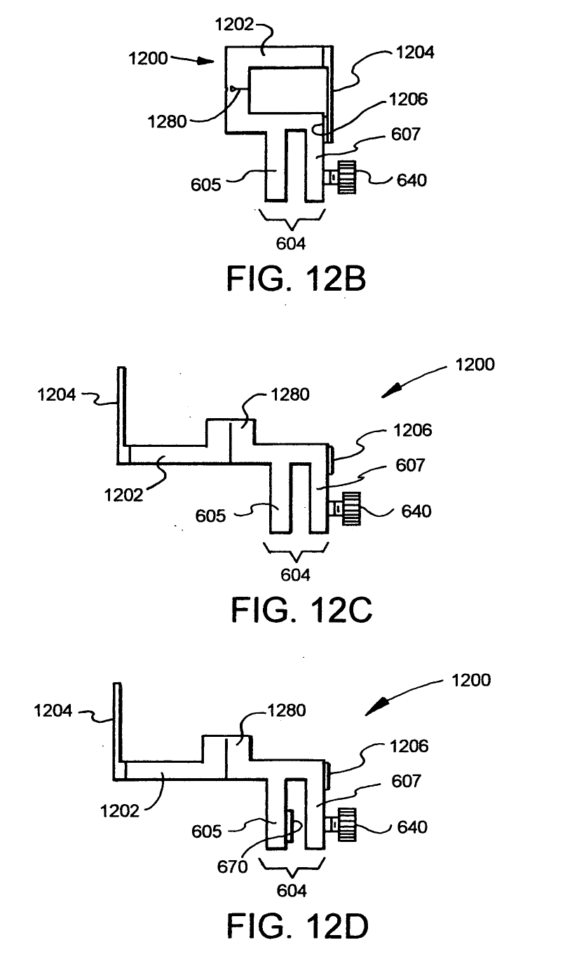

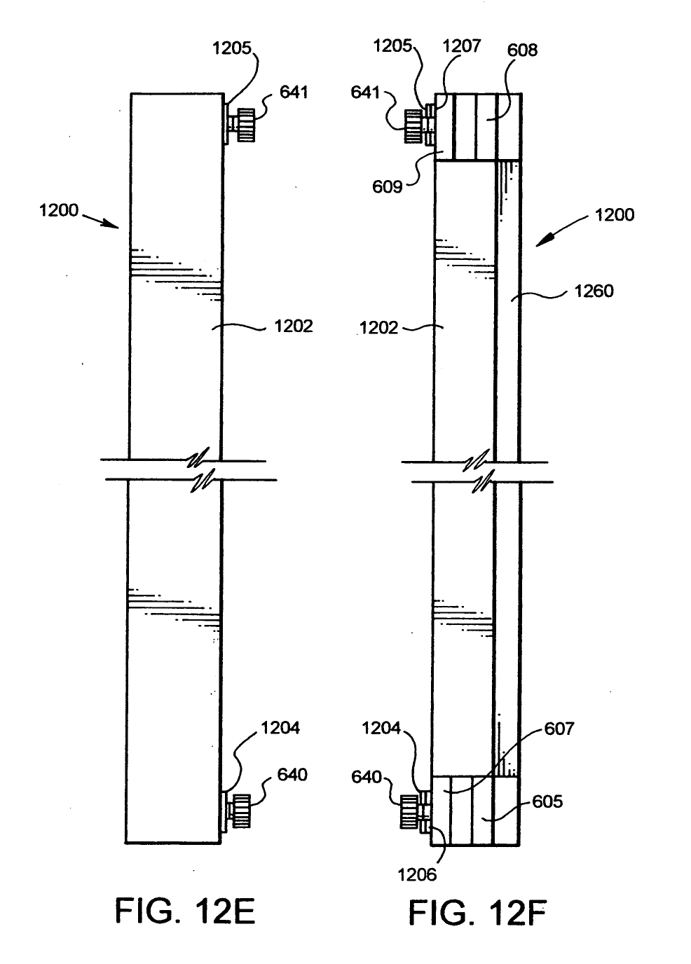

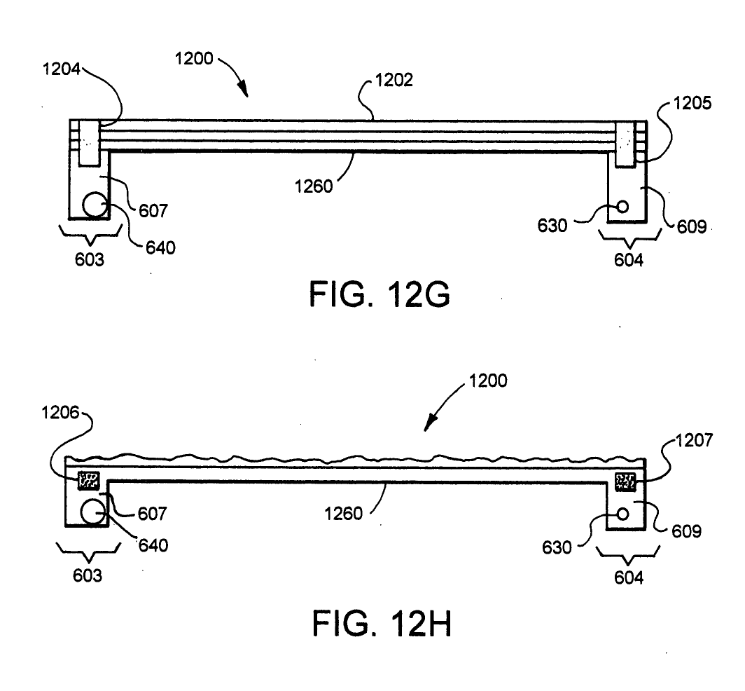

With reference now to FIGS. 12A-12H, various views of an exemplary hanging file retainer with locking screws or double sided tape for securing the hanging file retainer to a file drawer rail and a hinged retaining member with Velcro for securing the retaining member closed are shown in accordance with one embodiment of the present invention. FIG. 12A shows a perspective view of hanging file retainer 1200 in accordance with one embodiment of the present invention. FIG. 12B shows an end of hanging file retainer 1200 in a closed position in accordance with one embodiment of the present invention. FIG. 12C shows an end of the hanging file retainer 1200 in an open position in accordance with one embodiment of the present invention. FIG. 12D shows an end of the hanging file retainer 1200 in an open position and showing the alternative double-stick tape 670 mounting rather than screw mounting 641 or 640 for mounting the hanging file retainer 1200 to a file drawer rail in accordance with one embodiment of the present invention. FIGS. 12E and 12F show top and bottom views respectively of hanging file retainer 1200 in accordance with one embodiment of the present invention. FIG. 12G shows a side open view of hanging file retainer 1200 in accordance with one embodiment of the present invention. FIG. 12H shows a side closed view of hanging file retainer 1200 with the top not shown in accordance with one embodiment of the present invention.

Hanging file retainer 1200 is virtually identical to hanging file retainer 900 except that rather than molded pin locks 904 and 905 for securing the a removable retaining member 902 to the first and second attaching members 603 and 604, a hinged retaining member 1202 with hook and loop attachments 1204 and 1205 (such as, for example, Velcro) is used. Retaining member 1202 pivots about molded hinge 1280 between open and closed positions. Retaining member 1202 may be secured to the first and second attachment members 603-604 through attaching hook and loop connection pieces 1204 and 1205 on retaining member 1202 to respective complementary hook and loop connection pieces 1206 and 1207 on respective ones of first and second attachment members 603 and 604. Top attachment members 1226 and 1216 are slightly different from top attachment members 606 and 616 utilized in other embodiments and described above. Top attachment member 1226 extends out past first vertical attachment members 605 and 608 and is coupled to linking member 1260. Linking member 1260 connects attaching members 603 and 604.

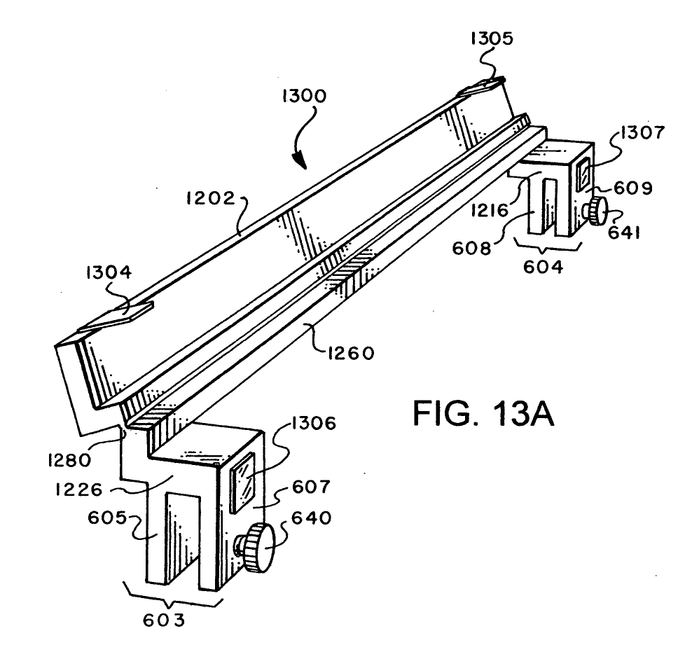

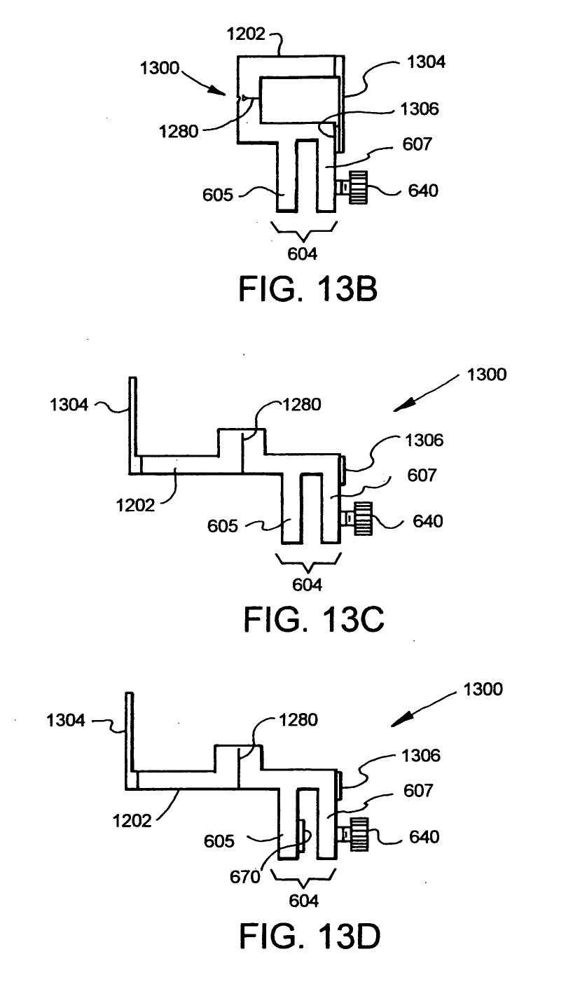

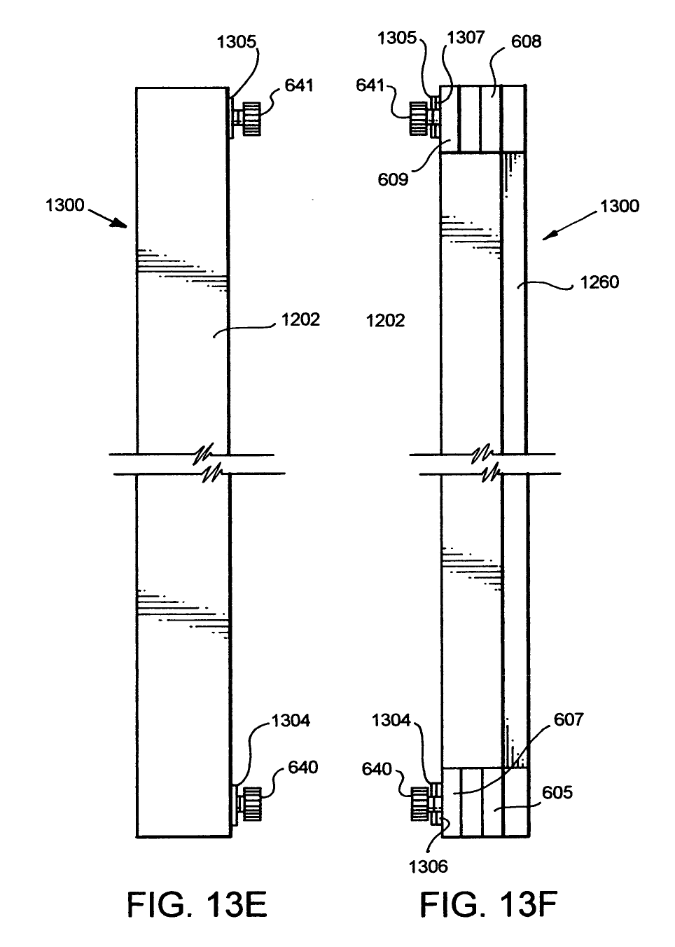

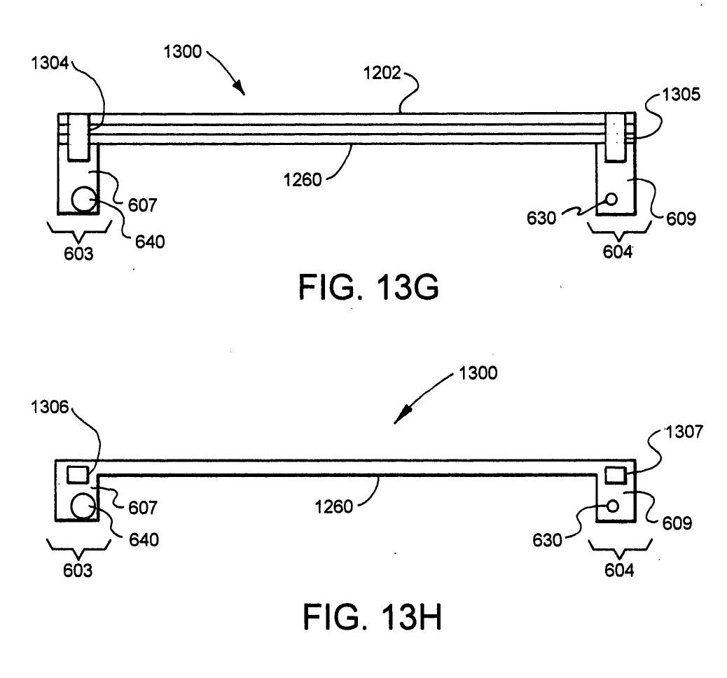

With reference now to FIGS. 13A-13H, various views of an exemplary hanging file retainer with locking screws or double sided tape for securing the hanging file retainer to a file drawer rail and a hinged retaining member with magnets for securing the retaining member closed are shown in accordance with one embodiment of the present invention. FIG. 13A shows a perspective view of hanging file retainer 1300 in accordance with one embodiment of the present invention. FIG. 13B shows an end of hanging file retainer 1300 in a closed position in accordance with one embodiment of the present invention. FIG. 13C shows an end of the hanging file retainer 1300 in an open position in accordance with one embodiment of the present invention. FIG. 13D shows an end of the hanging file retainer 1300 in an open position and showing the alternative double-stick tape 670 mounting rather than screw mounting 641 or 640 for mounting the hanging file retainer 1300 to a file drawer rail in accordance with one embodiment of the present invention. FIGS. 13E and 13F show top and bottom views respectively of hanging file retainer 1300 in accordance with one embodiment of the present invention. FIGS. 13G shows a side open view of hanging file retainer 1300 in accordance with one embodiment of the present invention. FIGS. 13H shows a side closed view of hanging file retainer 1300 with the top not shown in accordance with one embodiment of the present invention.

Hanging file retainer 1300 is virtually identical to hanging file retainer 1200 except that rather than Velcro 1204 and 1205 for securing the a removable retaining member 902 to the first and second attaching members 603 and 604, metal pieces 1304 and 1305 are affixed to retaining member 1202 which secure the retaining member 1202 in a closed position when proximate to magnets 1306 and 1307 affixed to respective ones of first attachment members 603-604.

Although described throughout primarily with reference to hanging file retainers in which the attaching members are located at the extreme ends of a retaining member, the present invention is not limited to such embodiments. In some embodiments, the retaining member may extend past one or both attaching members such that one or both attaching members are not at an extreme end of the retaining member. Furthermore, although described primarily with reference to hanging file retainers having two attaching members, the present invention is not limited to such and may include only a single attaching member or three or more attaching members.

The term Velcro has been used throughout the description as one mechanism for securing a retaining member to an attaching member for a hanging file folder retaining device. However, Velcro is a specific brand of a generic type of fastener called hook and loop fasteners. Any type of hook and loop fastener may be used in place of Velcro in any embodiment of the present invention that includes Velcro. Hook and loop fasteners consist of two layers: a “hook” side, which is a piece of fabric covered with tiny plastic hooks, and a “loop” side, which is covered with even smaller and “hairier” plastic loops. There are many variations to this which include hooks on both sides, for example. When the two sides are pressed together, the hooks catch in the loops and hold the pieces together.

In embodiments in which metal and magnets are used as a fastener, the metal may be replaced with a complimentary magnet configured such that the complementary pair of magnets are attracted to each other. It should also be noted that the retaining members in the various embodiments described above are typically at least long enough to span the distance between the first and second attaching members, but in some other embodiments, the retaining member may be longer such that the retaining member extends past one or both attaching members. Furthermore, although described primarily with reference to embodiments in which two attaching members are utilized, the present invention is not limited to such. Those skilled in the art will recognize that other numbers of attaching members are possible in other embodiments.

To aid the Patent Office, and any readers of any patent issued on this application in interpreting the claims appended hereto, it is noted that applicant does not intend any of the appended claims to invoke paragraph 6 of 35 U.S.C. § 112 as it exists on the date of filing unless the words “means for” are used in the particular claim. Furthermore, none of the description in the present application should be read as implying that any particular element, step, or function is an essential element which must be included in the claim scope: THE SCOPE OF THE PATENTED SUBJECT MATTER IS DEFINED ONLY BY THE ALLOWED CLAIMS. Thus, the extent of legal protection will be determined by the limitations recited in the allowed claims and their equivalents. Unless explicitly recited, other aspects of the present invention as described in this specification do not limit the scope of the claims.

As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Furthermore, no element described herein is required for the practice of the invention unless expressly described as “essential” or “critical”.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A hanging file folder retainer, comprising:
a first attaching member for coupling to a hanging file drawer rail;
a second attaching member for coupling to the hanging file drawer rail wherein the second attaching member is linearly disposed from said first attaching member;
a retaining member having a length sufficient to at least span the distance between said first and second attaching members and functionally coupled to said first and second attaching member such that, in at least one functional position, said retaining member inhibits hanging file tabs from disengaging from the hanging file drawer rail.

2. The hanging file folder retainer as recited in claim 1, wherein the first attaching member clips onto the hanging file drawer rail.

3. The hanging file folder retainer as recited in claim 1, wherein the first attaching member, the second attaching member, and the retaining member comprise a continuous semi-rigid material.

4. The hanging file folder retainer as recited in claim 1, wherein at least one of the first attaching member, the second attaching member, and the retaining member comprise a semi-rigid material.

5. The hanging file folder retainer as recited in claim 4, wherein the semi-rigid material comprises a thermoplastic.

6. The hanging file folder retainer as recited in claim 1, wherein the first attaching member comprises a thumb screw for affixing the first attaching member to the hanging file drawer rail.

7. The hanging file folder retainer as recited in claim 1, wherein the retaining member is configured to pivot about an axis between at least a closed position and an open position wherein the hanging file folder tabs are inhibited from disengaging from the hanging file drawer rail when the retaining member is in the closed position and wherein hanging file folders may be removed from the hanging file drawer when the retaining member is in the open position.

8. The hanging file folder retainer as recited in claim 7, wherein the retaining member pivots about a pivot axis that is substantially perpendicular to a line defined by the first and second attaching members.

9. The hanging file folder retainer as recited in claim 7, wherein the retaining member pivots about a pivot axis that is substantially parallel to a line defined by the first and second attaching members.

10. The hanging file folder retainer as recited in claim 1, wherein the retaining member comprises a first and a second end wherein at least one of the first and second ends comprises a snap lock for functionally attaching the retaining member to one of the first and second attaching members.

11. The hanging file folder retainer as recited in claim 1, wherein the retaining member is removable and comprises a separate discrete component from the first and second attaching members.

12. The hanging file folder retainer as recited in claim 1, wherein said retaining member comprises one of a removable member and a pivoting member, further comprising:
at least one securing member for securing said retaining member in a closed position.

13. The hanging file folder retainer as recited in claim 12, wherein the securing member comprises at least one of a screw, a molded pin lock, a hook and loop fastener, and a magnet.

14. A hanging file folder retainer, comprising:
attaching means for securing at least a part of the hanging file folder retainer to a hanging file drawer rail;
retaining means functionally coupled to said attaching means and configurable for at least an open and a closed position, wherein when configured in said closed position said retaining means inhibit dislodging of a hanging file folder from the hanging file drawer rail.

15. The hanging file folder retainer as recited in claim 14, further comprising:
hinging means for functionally coupling the retaining means to the attaching means wherein the retaining means is configured to pivot between at least a closed position and an open position about said hinging means.

16. The hanging file folder retainer as recited in claim 14, further comprising:
securing means for securing said retaining means in a closed position.

17. The hanging file folder retainer as recited in claim 16, wherein the securing means comprise at least one of adhesive means, mechanical means, and electromagnetic means.

18. The hanging file folder retainer as recited in claim 16, wherein the securing means comprise at least one of a molded pin lock, a thumb screw, a hook and loop fastener, and a magnetic fastener.

19. The hanging file folder retainer as recited in claim 14, wherein said retaining means is removable from said attaching means.

20. The hanging file folder retainer as recited in claim 14, wherein said attaching means comprise adhesive means.
